(19) United States
(12) Patent Application Publication
(10) Pub. No.: US 2007/0215705 A1
(43) Pub. Date: Sep. 20, 2007

(54) Mailpiece automated quality control

(75) Inventor: Hernan Borja, Centreville, VA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: United States Postal Service

(21) Appl. No.: 11/710,272

(22) Filed: Feb. 23, 2007

Related U.S. Application Data
(63) Continuation of application No. 10/956,213, filed on Sep. 30, 2004, now abandoned.
(60) Provisional application No. 60/517,475, filed on Nov. 5, 2003.

(51) Int. Cl. G06K 9/80

(52) U.S. Cl. 235/462.1

(57) ABSTRACT

An automated quality assurance system includes an imager that receives an item having a data area and provides an image of the data section; and an analyzer that obtains at least one parameter from the image related to the data area and determines whether the at least one parameter from the image conforms to a specification. The item can be a mailpiece and the data area can include an address and a barcode. In such cases, parameters regarding the printing of address and barcode can be determined and compared with the specification. Further, the data contained in the address and the barcode can be compared for consistency and conformance with the specification.

### RELATED APPLICATION

The present application is related to and claims priority from U.S. Provisional Application 60/517,475, filed on Nov. 5, 2003, which is herein incorporated by reference in its entirety.

### DESCRIPTION

1. Technical Field

The present invention is related to quality control in printing of a data area and, in particular, to conducting quality analysis to determine whether data printed in the data area meets standards set by a set of specifications.

2. Background

Data is often printed onto areas for later processing by an automated processing system. Some examples include addresses and barcodes printed onto delivery items (e.g., mailpieces), barcodes printed onto labels for pricing or inventory automation, checks that include barcodes to record account information, and credit card receipts. Barcodes are utilized in many areas, including mail and other delivery items, store pricing, product identification, product tracking, and other areas. In some cases, the quality of printing of such a barcode or address can degrade over time so that data may be erroneously read from the data area.

The United States Postal Service (USPS), for example, provides postage discounts to senders who print barcodes on delivery items. The printed barcodes correspond to the identity of the destination and are prepared according to a sort plan. Currently, there is no method available to determine the overall quality of the barcode of a delivery item while the barcode is being printed.

A quality barcoded mailpiece processes well through the automation process of the USPS. The Domestic Mail Manual (OMM) published by the USPS sets the criteria and specifications for the quality of barcodes required for senders, or mailers, to take advantage of discounted price schedules. If the barcode quality of a mailing deviates from the set standard, the mailing may not be efficiently handled through the USPS automation process and should not merit the discount.

Therefore, there is a need for checking the quality of the barcode production of a delivery item produced by a sender seeking discounts. Further, there is a need for quality checking of data that is printed in a data area.

### SUMMARY

Consistent with the invention, an automated quality control system to check the quality of data printed in a data area of a delivery item is presented. An automated quality assurance system according to the present invention can include an imager that receives an item having a data area and provides an image of the data area; and an analyzer that obtains at least one parameter from the image related to the data area and determines whether the at least one parameter from the image conforms to a specification.

In some embodiments, the item may be a delivery item such as a mailpiece and the data area includes an address and a barcode. In some embodiments, a parameter related to the printing of a barcode is determined and compared against the specification. In some embodiments, a parameter related to the printing of an address is determined and compared against the specification. In some embodiments, data read from the barcode is compared against data determined from the address. The analyzer may include an image recognition system to determine the data read from the barcode and the address. The data determined from the address may be obtained by a look-up procedure. In some embodiments, a printer coupled to the quality assurance system that prints the data area may be stopped if a parameter falls outside the specification.

A method of providing automated quality assurance according to the present invention can include imaging a data area of a piece; determining at least one parameter from the data area; and comparing the at least one parameter with a specification. Again, the delivery item may be a mailpiece and the data area can include an address and a barcode.

In some embodiments, determining at least one parameter includes determining a parameter related to the printing of an address. In some embodiments, data read from the bar code can be compared to data determined from the address. Bar code data and an address can be determined by image recognition software. Data determined from the address may be obtained by a look-up process.

These and other embodiments are further discussed below with respect to the following figures. It is to be understood that both the foregoing general description and the following detailed description are exemplary and explanatory only and are not restrictive of the invention, as claimed. These and other embodiments are further discussed below with respect to the following claims.

### BRIEF DESCRIPTION OF THE DRAWINGS

FIG. 1 illustrates an embodiment of an automated quality control system consistent with the present invention.

FIG. 2 shows a flow chart of an embodiment of an automated quality control system consistent with the present invention.

### DESCRIPTION OF THE EMBODIMENTS

In some embodiments consistent with the present invention, mailpieces are presented to an image acquisition unit where an image of the mailpiece is captured. From the image, address and barcode components can be identified. The address component can then be checked for conformance to U.S. Postal Service (USPS) specifications for automation purposes such as, for example, address block position and composition. In addition, the address information can be determined and utilized to determine a barcode that conforms with the USPS guidelines. Nonconforming addresses can be reported.

The barcode identified in the image can also be analyzed for printing quality and data composition. The result of such an analysis can be checked for conformance with the USPS DMM standards. Any non-conforming individual mail piece can also be identified. In some embodiments, the analysis can produce a trend in the conformance of the barcode printing parameters. Trend data can be analyzed to report when a particular barcode parameter has deteriorated enough to impede automation, and therefore predict when such mail pieces may no longer be eligible for automation discounts based on the acceptance level stipulated by the USPS Bulk Mail acceptance process.

In addition, the data content of the barcode can be compared to the data determined from the address and non-conforming mail pieces can be reported. Data obtained from the barcode can be checked for conformance with USPS standards. In some embodiments, default add-on zipcode information or any arbitrary string of information can be read from the barcode.

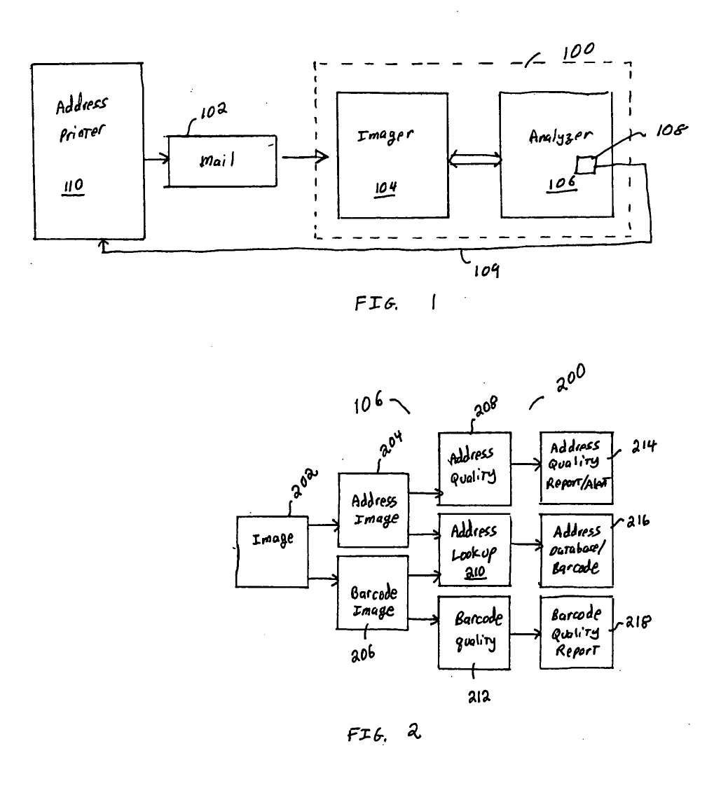

FIG. 1 illustrates an embodiment of an automated quality control system 100 according to the present invention. In system 100, a delivery item 102, which can be, for example, a mailpiece, is scanned in an imager 104. Delivery item 102 includes a data area, for example, where an address and barcode are printed, printed by a printer 110. In some embodiments, printer 110 prints the data area according to the requirements of a specification. In some embodiments, for example, the data area includes address and barcode combinations that conform to the requirements of the USPS DMM regarding automation-compatible mail. Such requirements are, for example, stated in section A800 of the DMM. In accordance with the requirements of the DMM, to qualify for automation rates, addresses must be sufficiently complete to enable matching to the current USPS ZIP+4™ Product when used with current Coding Accuracy Support System (CASS)—certified address matching software. Requirements for barcodes are defined in section C840 of the DMM. The CASS system is discussed in section A950 of the DMM and improves the accuracy of delivery point codes, ZIP+4™ codes, 5 digit ZIP codes, and carrier route codes on mailpieces. A CASS certified address matching software insures that routing data encoded into a bar code is properly matched with the address. Data encoded into the bar code, therefore, is determined by looking up the data in a properly encoded mailing list.

Imager 104 shown in FIG. 1 can be any device capable of imaging the data area of delivery item 102 such as, for example, a CCD camera. The image data obtained by imager 104 is then transmitted to an analyzer 106. Analyzer 106 can be any computing device capable of analyzing the image data obtained by imager 104. In some embodiments, the data area can include alphanumeric data. In such case, analyzer 106 may include an image recognition system capable of determining the alphanumeric data from the image data. In some embodiments, the data area can include a bar code. Again, analyzer 106 may include an image recognition system capable of reading the data encoded in the bar code from the image data.

Analyzer 106 may, for example, by a PC-based computer system interfaced with imager 104. Analyzer 106 can include software code that may be stored on a fixed medium (e.g., hard disk drive), volatile or non-volatile memory, or a removable medium (e.g., floppy disk, CD-ROM, or flash card). When analyzer 106 executes the software code, analyzer 106 operates to determine the quality of data printed in the data area of delivery item 102.

In some embodiments, system 100 can receive a series of individual delivery items 102 and serially analyze the data area on each delivery item 102. In some embodiments, analyzer 106 can be located within automation equipment capable of automatically handling piece 106 according to data in the data area. In some embodiments, analyzer 106 can be part of a mailer's automatic address and bar code generation equipment. Moreover, analyzer 106 may include a generator 108 that generates a “stop” signal 109 to stop printer 110 if either the address or the barcode is determined to not conform to the standard.

In some embodiments, system 100 assesses the quality of alphanumeric symbols, for example, business or residential addresses, or other symbols, for example, barcodes, during the process by which the data is printed onto pieces 102. Analyzer 106 can check physical printing parameters regarding data printed in the data area and also the information in the data area (e.g., the address and the data encoded in the barcode). Analyzer 106 checks the data obtained regarding the alphanumeric symbols or other symbols against a specified set of requirements. For example, the USPS sets stringent specifications regarding the quality of residential and physical addresses on deliverable items handled by the USPS. Such specifications are set forth in the USPS Domestic Mail Manual, which is herein incorporated by reference in its entirety.

In some embodiments, system 100 can be part of a production process wherein Numeric Encoding barcodes corresponding to the address for the delivery point and the ZIP+4 code information are generated. In some embodiments, system 100 can be part of a sampling production line process that selects the delivery address information. In some embodiments, system 100 then acquires mailpiece images while in production or during a sampling production line process, selects the delivery address information and the Numeric Encoding barcode for the delivery point and the ZIP+4 code information from the face of each piece 102, and performs a detailed address and barcode quality analysis to insure conformance with the DMM specification.

FIG. 2 illustrates a flow chart of an embodiment of analyzer 106 of a system 100 according to the present invention that can be utilized to process mail. As shown in FIG. 1, a delivery item 102 is imaged to obtain an image 202 shown in FIG. 2. From image 202, an address acquisition component 204 identifies the delivery address and a barcode acquisition component 206 identifies a barcode. In address quality component 208, the address is checked for printing quality by determining conformance with the requirements of the DMM. Those requirements include, for example, requirements on address block position, character type, character reflectance, and character size. Whether or not the address itself meets the requirements of a standard, for example the standard of the DMM, is reported in address quality report component 214. Further, if an aspect of the address quality is sufficiently divergent from optimum values, address quality report component 214 may alert printer 110 (FIG. 1) to stop printing until printer 110 has been serviced.

In component 206, a barcode portion of image 202 can be identified. Once the barcode portion of image 202 is identified, it is checked for printing quality in barcode quality component 212. Barcode quality checks can include an analysis of printing quality and data composition. The quality of the barcode printing can then be checked against the standards put forth in the USPS DMM. Such standards can include, for example, location and space of the barcode on the mailing label, amount of space left around a barcode, dimensions of the bars and spacing of the bars in the barcode, the reflectance of the barcode, and the skew and baseline shift of the barcode. Such standards are further enumerated in, for example, section C840 of the DMM.

Once the printing quality of the barcode is assessed in barcode quality component 212, a report of that quality can be made in barcode quality report 218. In particular, non-conforming barcodes can be reported by barcode quality report component 218. In some embodiments, if the barcode printing quality determined in barcode quality 212 is outside of a set of specifications for any reason, barcode quality report 218 may provide a signal to address printer 110 to halt printing of addresses and barcodes on delivery item 102 until the printer has been serviced. For example, if barcode quality 212 determines that a “bars-per-inch” parameter or a reflectance parameter, for example, is outside of the specification, or in some embodiments sufficiently divergent from optimum settings, barcode quality report 218 may instruct printer 110 to stop printing and indicate that maintenance of the printer is necessary.

Further, in some embodiments, the address quality determined in address quality 208 and the barcode quality assessed in barcode quality 212 can be tracked in order to determine a trend. By identifying trends in the deterioration of barcode quality or address quality, for example, a service warning can be provided to alert a user to perform maintenance on printer 110 before any of the quality parameters become outside of the requirements of a specification.

Address lookup 210 can include image recognition software. Such image recognition software can, for example, read the data encoded in the barcode or determine the address from the address image. In address lookup 210, the barcode image determined in barcode 206 is read and the encoded ZIP code determined. By obtaining the address from the address image determined in address 204, the appropriate ZIP code can be determined. The address zip code can be obtained from a list of addresses included in, for example, the CASS certified software. The address ZIP code can be determined by, for example, CASS certified software in address lookup 210. The address zip code can then be compared with the ZIP code determined by reading the barcode obtained in barcode 206. In address database/barcode 216, any discrepancy is reported so that a non-conforming delivery item 102 can be rejected. In some embodiments, address lookup 210 also determines default add-on ZIP code information or any arbitrary string of data that may or may not conform with the USPS standards.

Adding quality control system 110 to a printer 110 in order to check the data area of delivery item 102 printed by printer 100 can result in improved consistent quality for automation compatible mail. Further, addition of quality control system 100 according to the present invention to the automated mail flow system in the USPS results in rejection of non-conforming mailpieces 102 before significant routing has taken place.

Although quality control system 100 has been described herein in the context of determining the quality of addresses and barcodes for automated delivery item handling capabilities, systems according to the present invention can also be utilized to monitor the quality of any kind of printing image that is required to meet certain specification standards. Some examples include check printing, credit card receipt printing, inventory control barcode printing. Such items often are fed to optical character recognition (OCR) equipment for reading and strict adherence to printing specifications may be required in such operations.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An automated quality assurance system, comprising:
an imager that receives a item having a data area and provides image data related to an image of the data section; and
an analyzer that obtains at least one parameter from the image data and determines whether the at least one parameter conforms to a specification.

2. The system of claim 1, wherein the item is a mailpiece and the data area includes an address and a barcode.

3. The system of claim 2, wherein a parameter related to the quality of a barcode is determined and compared against the specification.

4. The system of claim 2, wherein a parameter related to the quality of an address is determined and compared against the specification.

5. The system of claim 2, wherein a data read from the barcode is compared against a data determined from the address.

6. The system of claim 5, wherein the analyzer comprises an image recognition system to determine the data read from the barcode and the address.

7. The system of claim 6, wherein the analyzer comprises a look-up to determine the data determined from the address.

8. The system of claim 1, further comprising a printer that prints the data area.

9. The system of claim 8, wherein the analyzer comprises a signal generator to generate a signal to stop the printer when the at least one parameter does not conform to the specification.

10. The system of claim 1, wherein the data area comprises a combination of alphanumeric symbols.

11. The system of claim 1, wherein the data area comprises a barcode.

12. A method of providing automated quality assurance, comprising:
generating image data of a data area of a delivery item;
determining at least one parameter from the image data; and
comparing the at least one parameter with a specification.

13. The method of claim 12, wherein the delivery item is a mail and the data area includes an address and a barcode.

14. The method of claim 13, wherein determining at least one parameter includes determining a parameter related to the printing of a barcode.

15. The method of claim 13, wherein determining at least one parameter includes determining a parameter related to the printing of an address.

16. The method of claim 13, wherein determining comprises:
generating address data from the image data;
generating barcode data from the image data; and
comparing the barcode data with the address data.

17. The method of claim 16, wherein generating barcode data includes reading data encoded in the barcode with an image recognition system.

18. The method of claim 16, wherein generating address data includes looking up a data based on an address read from the image data with an image recognition system.

19. The method of claim 12, further including printing the data area on the delivery item.

20. The method of claim 19, further including stopping the printer when the at least one parameter does not conform to the specification.

21. The method of claim 12, wherein the data area includes a combination of alphanumeric symbols.

22. The method of claim 12, wherein the data area includes a barcode.

23. A removable computer medium, comprising a software code for
generating image data of a data area of a delivery item;
determining at least one parameter from the image data; and
comparing the at least one parameter with a specification.

24. The medium of claim 23, wherein the delivery item is a mail and the data area includes an address and a barcode.

25. The medium of claim 24, wherein determining at least one parameter includes determining a parameter related to the printing of a barcode.

26. The medium of claim 24, wherein determining at least one parameter includes determining a parameter related to the printing of an address.

27. The medium of claim 24, wherein determining comprises:
generating address data from the image data;
generating barcode data from the image data; and
comparing the barcode data with the address data.

28. The medium of claim 27, wherein generating barcode data includes reading data encoded in the barcode with an image recognition system.

29. The medium of claim 27, wherein generating address data includes looking up a data based on an address read from the image data with an image recognition system.

30. The medium of claim 23, wherein the software further includes printing the data area on the delivery.

31. The medium of claim 30, wherein the software further includes stopping the printer when the at least one parameter does not conform to the specification.

32. The medium of claim 23, wherein the data area includes a combination of alphanumeric symbols.

33. The medium of claim 23, wherein the data area includes a barcode.
